(19) United States
(12) Patent Application Publication
(10) Pub. No.: US 2018/0062384 A1
(43) Pub. Date: Mar. 1, 2018

(54) CURRENT INTERRUPTION ARRANGEMENT, BATTERY SYSTEM, CONTROLLER AND METHOD FOR INTERRUPTING A CURRENT FLOW BETWEEN A BATTERY AND A LOAD OF THE BATTERY

(71) Applicant: Robert Bosch GmbH, Stuttgart (DE)

(72) Inventors: Francois Mothais, Stuttgart (DE); Gergely Galamb, Traunstein (DE)

(21) Appl. No.: 15/687,889

(22) Filed: Aug. 28, 2017

(30) Foreign Application Priority Data
Aug. 30, 2016 (DE) 10 2016 216 341.8

(51) Int. Cl. H02H 7/18; H01M 10/42

(52) U.S. Cl. CPC H02H 7/18; H01M 2010/4271; H01M 2220/20; H01M 10/4257

(57) ABSTRACT

A current interruption arrangement for a battery system. The current interruption arrangement includes at least one current interruption unit for interrupting an electrical current flow between a battery of the battery system and a load of the battery. The current interruption unit has at least one power semiconductor for interrupting and establishing the current flow between the battery and the load of the battery, and at least one surge arrester connected in parallel with the power semiconductor.

### BACKGROUND OF THE INVENTION

The present invention relates to a current interruption arrangement, to a battery system, in particular a high-voltage battery system of an electric vehicle, to a controller and to a method for interrupting an electrical current flow between a battery and a load.

The general prior art discloses the fact that a combination of contactors and fuses is used to interrupt overcurrents or short-circuit currents in battery systems. For example, a contactor is installed at each pole of a battery of a battery system and is opened in the event of a fault in a manner triggered by a controller of monitoring electronics. If excessively high currents, for example in a range of 2 kA to 10 kA, occur in the event of a short circuit, a fuse connected in series with the contactors interrupts the current after 0.1 ms to 2 s.

DE 10 2008 043 381 A1 discloses an apparatus having a high-voltage power supply assembly and a controller therefor. In the high-voltage power supply assembly, a high-voltage battery assembly is connected to a circuit breaker assembly having electromechanical or electronic high-voltage circuit breakers (relays). These have the task, inter alia, of electrically connecting the engine control unit or other high-voltage loads to the high-voltage battery when the vehicle electronics are switched on and of safely disconnecting it/them from the high-voltage battery during switch-off or in the event of safety-critical faults.

### SUMMARY OF THE INVENTION

According to the present invention, a cost-effective current interruption arrangement for a battery system is provided, which current interruption arrangement can be used to safely achieve shorter switching times, in particular when interrupting an electrical current flow between a battery of a battery system and at least one load of the battery. In addition, a battery system having the current interruption unit, a method for interrupting an electrical current flow between the battery and the load of the battery by means of the current interruption unit and a controller which is configured to carry out the method using the current interruption unit are provided in the present case.

Further features of the invention emerge from the description and the drawings. In this case, it goes without saying that features and details described in connection with the current interruption arrangement also apply in connection with the battery system according to the invention, the method according to the invention, the controller according to the invention and vice versa in each case, with the result that reference is or can be always reciprocally made with respect to the disclosure for the individual aspects of the invention.

A first aspect of the present invention provides a current interruption arrangement for a battery system. The current interruption arrangement has at least one current interruption unit for interrupting an electrical current flow between a battery of the battery system and a load of the battery. The current interruption unit has at least one power semiconductor for interrupting and establishing the current flow between the battery and the load of the battery. At least one surge arrester is also connected in parallel with the power semiconductor.

As a result of the surge arrester being connected in parallel with the power semiconductor according to the invention, transient overvoltages at the power semiconductor can be advantageously reduced in a reliable manner and without destroying or damaging the power semiconductor. An overvoltage can also be reduced particularly quickly by the surge arrester connected in parallel. As soon as an overvoltage occurs at the power semiconductor, the surge arrester connected in parallel turns on and thermally reduces the energy produced in the process. The surge arrester is preferably configured in such a manner that it becomes DC-isolating as soon as a voltage difference between the surge arrester and the power semiconductor falls below a defined value.

The power semiconductor used is advantageously designed for use on a high-voltage battery or in a high-voltage battery system having a dielectric strength of 650 V, for example. The battery, including an inverter, has an inductance of 1 to 50 pH.

The surge arrester according to the invention can also be connected in parallel instead of a possible further power semiconductor. In comparison with a further power semiconductor, a considerable cost advantage can be achieved by means of the surge arrester. An average surge arrester costs approximately one tenth of an average power semiconductor. A standard component which is designed for overvoltage protection can preferably be used as the surge arrester. This advantageously makes it possible to achieve particularly high reliability during voltage reduction, in particular in comparison with an embodiment having a further power semiconductor, since power semiconductors are not designed, as standard, for a high energy reduction in the case of overvoltage shutdowns. The surge arrester is preferably designed for power peaks of more than 10 kW, particularly preferably of more than 50 kW.

The current interruption arrangement may be in the form of an electrical or electromechanical switch which is configured and arranged to interrupt an electrical current flow between the battery or at least one battery and the load in a main current path. The main current path can be understood as meaning a current path between the battery of the battery system and the load of the battery at a positive terminal and a negative terminal of the at least one battery. In this case, the main current path corresponds to a current path in which the contactors and the safety fuse described above with respect to the prior art are usually arranged.

The battery preferably has a plurality of battery cells which can be connected in series and/or in parallel. In this case, the battery system preferably also has a plurality of batteries. Both the battery cells of the batteries and the batteries themselves are preferably at least partially connected in series.

In the present case, the load can be understood as meaning a system which is or can be supplied with current and voltage from the at least one battery. In the present case, the load is, for example, a motor vehicle network or an electric motor which is connected to the motor vehicle network.

The present current interruption arrangement is preferably designed for use in a motor vehicle, in particular in a high-voltage battery system of an electric vehicle. In this case, the invention is not restricted to use in a road vehicle. It is thus possible for the current interruption arrangement to also be accordingly designed for use in a rail vehicle, in a watercraft, in an aircraft and/or in a robot. In addition, the current interruption arrangement may also be accordingly designed for use in a stationary system.

Using the power semiconductor or at least one power semiconductor advantageously makes it possible to short-circuit the main current path in a particularly rapid manner. A power semiconductor can be understood as meaning a semiconductor component which, when used in power electronics, is designed to control and switch high electrical currents and voltages, for example of more than 1 A to several 1000 A and voltages of more than 24 V. Transistors having suitable switching and power properties, for example, can be used as power semiconductors.

According to one development of the present invention, it is possible for the at least one power semiconductor to have a dielectric strength which is greater than a breakdown voltage of the at least one surge arrester. If the breakdown voltage of the surge arrester is 600 V, for example, the power semiconductor may advantageously have a dielectric strength of 650 V. In this case, the energy above 600 V at the surge arrester is reduced if an overvoltage occurs. The power semiconductor can accordingly be reliably protected thereby. In this sense, it has been found to be advantageous within the scope of trials of the present invention if the dielectric strength of the power semiconductor is between 3% and 20%, preferably between 5% and 15%, greater than the breakdown voltage of the at least one surge arrester.

In a current interruption arrangement according to the invention, it is also possible for a resistor to be connected in series with the at least one surge arrester. As a result, it is advantageously possible, even in the event of a breakdown of the surge arrester, for the energy resulting from the overvoltage to be able to be reduced within a very short time and for the power semiconductor to not be damaged or destroyed. The resistor connected in series is therefore used as safety for a fault in the surge arrester or if the surge arrester is not adequately dimensioned.

According to the present invention, it is also possible for the at least one power semiconductor to be in the form of a bipolar transistor with an insulated gate electrode (IGBT) in a current interruption arrangement. If the at least one power semiconductor is in the form of an IGBT, the main current path can be short-circuited in a particularly rapid and reliable manner and the overcurrent in the direction of the at least one battery can therefore be accordingly prevented or substantially prevented in a rapid and reliable manner. The IGBT also has particularly high voltage and current limits. This makes it possible to provide additional safety for the battery system in addition to the safety provided by the surge arrester. That is to say, the IGBT can control and switch voltage of 7 kV, for example, and currents of 4 kA, for example, in the case of a power of 100 MW, for example, in a non-destructive manner. In addition, powerless or substantially powerless control is possible by means of the IGBT. In addition, the IGBT has a particularly high pulse loading capability.

In a current interruption arrangement according to the invention, it is also possible for the at least one power semiconductor to be in the form of a power metal oxide semiconductor field-effect transistor (MOSFET). If the at least one power semiconductor is in the form of a power MOSFET, the main current path can be short-circuited in a particularly rapid and reliable manner as a result of the rapid switching time of the power MOSFET and an overcurrent in the direction of the at least one battery can therefore be accordingly prevented or substantially prevented in a rapid and reliable manner. Like the IGBT, the power MOSFET has particularly high voltage and current limits. The power MOSFET also has high robustness with respect to environmental influences. As a result, the power MOSFET is particularly well-suited to use in a motor vehicle.

In addition, according to the present invention, it is possible, in a current interruption arrangement, for the current interruption unit to have a plurality of power semiconductors for interrupting and establishing the current flow between the battery and the load, and for the plurality of power semiconductors to be connected in series. Heat which is produced when interrupting and restoring currents between the battery and the load of the battery can be distributed in an improved manner as a result of the plurality of power semiconductors connected in series. That is to say, this makes it possible to take into account the risk of overheating of an individual power semiconductor if, for example, the surge arrester is not adequately dimensioned or has a malfunction.

Another aspect of the present invention provides a battery system, in particular for a motor vehicle, preferably for an electric vehicle, having a current interruption arrangement as described in detail above. The battery system according to the invention therefore entails the same advantages as have been described in detail with respect to the current interruption arrangement according to the invention. The current interruption arrangement is preferably arranged directly or in the vicinity of a positive or negative side or at a corresponding pole of the battery.

Another aspect of the present invention provides a method for interrupting an electrical current flow between a battery and a load by means of a current interruption arrangement as described in detail above. Thermal energy produced in this case between the at least one power semiconductor and the at least one surge arrester when interrupting the current flow is divided between the at least one power semiconductor and the at least one surge arrester. The method according to the invention therefore also entails the same advantages as have been described in detail with respect to the current interruption arrangement according to the invention.

In one development of the method according to the invention, it is advantageous if the at least one power semiconductor for interrupting the current flow at least occasionally completely turns off and is at least occasionally operated in an active clamping mode. That is to say, the power semiconductor can be configured in such a manner that it completely turns off for part of a switch-off time, as a result of which the surge arrester is on, and is operated in the active clamping mode for another part of the switch-off time. In this case, the cut-off voltage or the dielectric strength of the power semiconductor is preferably selected to be smaller than the breakdown voltage of the surge arrester. This makes it possible to reduce any overvoltage in the present battery system in a particularly efficient manner. Within the scope of the present invention, it is also conceivable for the temperature at the surge arrester to be checked by means of a temperature sensor and for a fault message to be output or for the battery system to be directly switched off in the event of an excessively high temperature at the surge arrester.

In addition, one aspect of the present invention provides a controller for a battery system as described above, the controller being configured to carry out the method described above. For this purpose, the controller is connected to the battery system and/or the current interruption arrangement at least in terms of data technology by cable and/or radio. The controller according to the invention therefore also entails the same advantages as have been described in detail with respect to the current interruption arrangement according to the invention.

### BRIEF DESCRIPTION OF THE DRAWINGS

Further measures which improve the invention emerge from the following description of some exemplary embodiments of the invention which are schematically illustrated in the figures. All features and/or advantages, including design details and spatial arrangements, which emerge from the claims, the description or the drawing can be essential to the invention both per se and in the various combinations.

In the drawings:

FIG. 1 schematically shows a battery system according to an embodiment known in the prior art,

FIG. 2 schematically shows a battery system having a current interruption arrangement according to a first embodiment of the present invention,

FIG. 3 schematically shows a battery system having a current interruption arrangement according to a second embodiment of the present invention,

FIG. 4 schematically shows a battery system having a current interruption arrangement according to a third embodiment of the present invention, and

FIG. 5 schematically shows a graph for illustrating a current profile over time.

### DETAILED DESCRIPTION

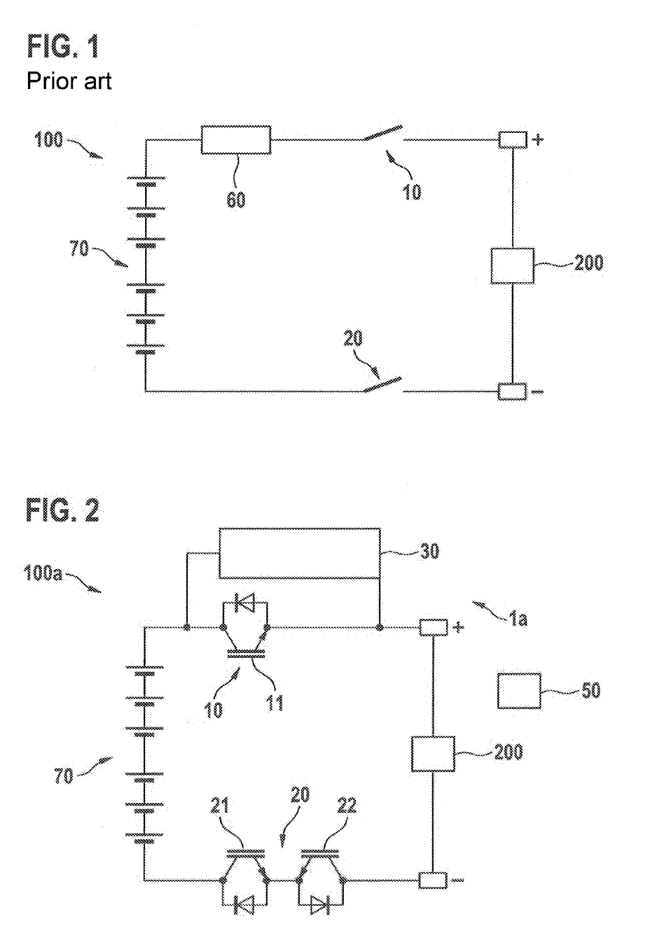

Elements having the same function and method of operation are each provided with the same reference symbol in FIGS. 1 to 5.

FIG. 1 illustrates a battery system 100 known in the prior art. The battery system 100 has a battery 70 and a load 200 of the battery 70. A current flow between the battery 70 and the load 200 can be interrupted or restored by means of a first contactor 10 and a second contactor 20. A safety fuse 60 is arranged in a main current path upstream of the first contactor 10, that is to say between the first contactor 10 and a positive pole of the battery 70.

FIG. 2 shows a battery system 100a having a current interruption arrangement 1a according to a first embodiment of the present invention. The current interruption arrangement 1a illustrated in FIG. 2 has a first current interruption unit 10 and a second current interruption unit 20. The two current interruption units 10, 20 are designed to interrupt an electrical current flow between a battery 70 of the battery system 100a and a load 200 of the battery 70. The first current interruption unit 10 also has a first power semiconductor 11 in the form of an IGBT. The second current interruption unit 20 has a third power semiconductor 21 in the form of an IGBT and a fourth power semiconductor 22 in the form of an IGBT. The power semiconductors 11, 21, 22 are each designed to interrupt and establish the current flow between the battery 70 and the load 200 of the battery 70. The current interruption arrangement 1a also has a surge arrester 30 which is connected in parallel with the first power semiconductor 11. In this case, the first power semiconductor 11 has a dielectric strength which is greater than the breakdown voltage of the surge arrester 30. FIG. 2 also illustrates a controller 50 which is configured to control and/or regulate the battery system 100a.

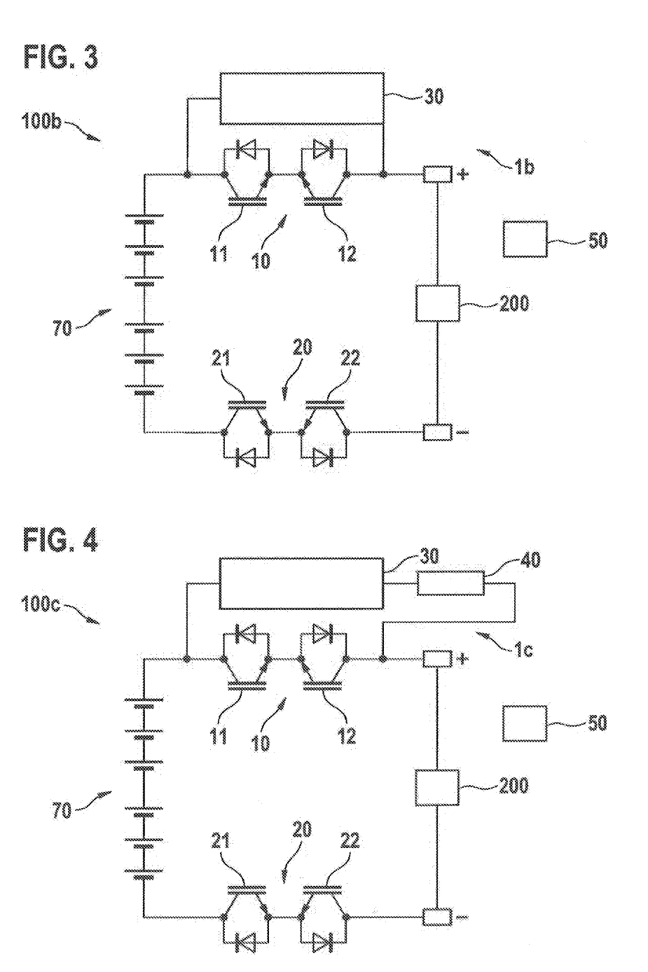

FIG. 3 shows a battery system 100b having a current interruption arrangement 1b according to a second embodiment of the present invention. The current interruption arrangement 1b illustrated in FIG. 3 has a first current interruption unit 10 and a second current interruption unit 20. The two current interruption units 10, 20 are designed to interrupt an electrical current flow between a battery 70 of the battery system 100b and a load 200 of the battery 70. The first current interruption unit 10 also has a first power semiconductor 11 in the form of an IGBT and a second power semiconductor 12 which is in the form of an IGBT and is connected in series with the first power semiconductor 11. The second current interruption unit 20 has a third power semiconductor 21 in the form of an IGBT and a fourth power semiconductor 22 in the form of an IGBT. The power semiconductors 11, 12, 21, 22 are each designed to interrupt and establish the current flow between the battery 70 and the load 200 of the battery 70. The current interruption arrangement 1b also has a surge arrester 30 which is connected in parallel with the first power semiconductor 11 and the second power semiconductor 12. The first power semiconductor 11 and the second power semiconductor 12 each have a dielectric strength which is greater than the breakdown voltage of the surge arrester 30. FIG. 3 also illustrates a controller 50 which is configured to control and/or regulate the battery system 100b.

FIG. 4 shows a battery system 100c having a current interruption arrangement 1c according to a third embodiment of the present invention. The current interruption arrangement 1c illustrated in FIG. 4 has a first current interruption unit 10 and a second current interruption unit 20. The two current interruption units 10, 20 are designed to interrupt an electrical current flow between a battery 70 of the battery system 100c and a load 200 of the battery 70. The first current interruption unit 10 also has a first power semiconductor 11 in the form of an IGBT and a second power semiconductor 12 which is in the form of an IGBT and is connected in series with the first power semiconductor 11. The second current interruption unit 20 has a third power semiconductor 21 in the form of an IGBT and a fourth power semiconductor 22 in the form of an IGBT. The power semiconductors 11, 12, 21, 22 are each designed to interrupt and establish the current flow between the battery 70 and the load 200 of the battery 70. The current interruption arrangement 1b also has a surge arrester 30 which is connected in parallel with the first power semiconductor 11 and the second power semiconductor 12. According to the embodiment illustrated in FIG. 4, a resistor 40 is also connected in series with the surge arrester 30. The first power semiconductor 11 and the second power semiconductor 12 each have a dielectric strength which is greater than the breakdown voltage of the surge arrester 30. FIG. 4 also illustrates a controller 50 which is configured to control and/or regulate the battery system 100c.

In the case of a method according to the invention for interrupting an electrical current flow between a battery 70 and a load 200 of the battery by means of one of the current interruption arrangements 1a, 1b, 1c illustrated, thermal energy produced in this case between the at least one power semiconductor 11, 12 and the surge arrester 30 when interrupting the current flow is divided between the at least one power semiconductor 11, 12 and the at least one surge arrester 30. In order to interrupt the current flow, the at least one power semiconductor 11, 12 is occasionally completely turned off and is occasionally operated in an active clamping mode.

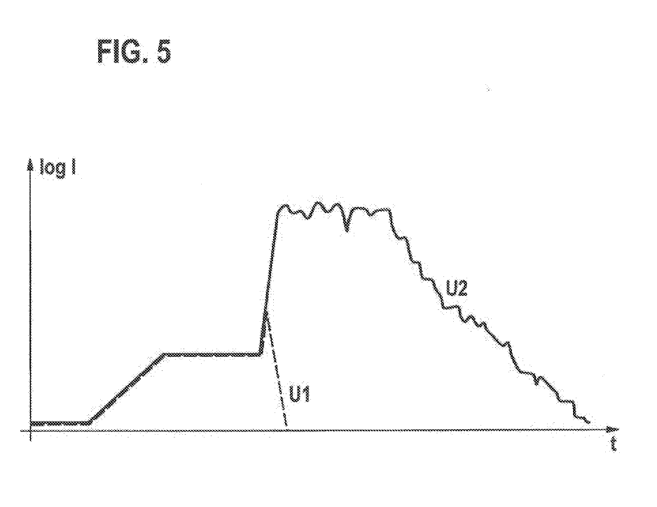

FIG. 5 shows a graph for illustrating a current profile over time when carrying out the method according to the invention. To be exact, FIG. 5 shows an overvoltage reduction U1 at a current interruption unit according to the invention in comparison with an overvoltage reduction U2 at a current interruption unit conventional in the prior art. As can clearly be seen in FIG. 5, an overvoltage can be reduced considerably more rapidly by the current interruption unit according to the invention, thus also producing a considerably smaller current rise.

The controller 50 illustrated in the figures is configured to carry out the method and is connected to the battery system 100 and/or the current interruption arrangement 1a; 1b; 1c via cables and/or in a wireless manner. In addition to the embodiments illustrated, the invention allows further design principles. The IGBTs illustrated in the figures may thus also be replaced with power MOSFETs, silicon carbide semiconductors, gallium nitride semiconductors or other power semiconductors.

1. A current interruption arrangement (1a; 1b; 1c) for a battery system (100a; 100b; 100c) comprising:
at least one current interruption unit (10) for interrupting an electrical current flow between a battery (70) of the battery system (100a; 100b; 100c) and a load (200) of the battery (70), the current interruption unit (10) having
at least one power semiconductor (11, 12) for interrupting and establishing the current flow between the battery (70) and the load (200) of the battery (70), and
at least one surge arrester (30) connected in parallel with the power semiconductor (11, 12).

2. The current interruption arrangement (1a; 1b; 1c) according to claim 1, wherein the at least one power semiconductor (11, 12) has a dielectric strength greater than a breakdown voltage of the at least one surge arrester (30).

3. The current interruption arrangement (1c) according to claim 1, wherein at least one resistor (40) is connected in series with the at least one surge arrester (30).

4. The current interruption arrangement (1a; 1b; 1c) according to claim 1, wherein the at least one power semiconductor (11, 12) is a bipolar transistor with an insulated gate electrode (IGBT).

5. The current interruption arrangement (1a; 1b; 1c) according to claim 1, wherein the at least one power semiconductor (11, 12) is a power metal oxide semiconductor field-effect transistor (MOSFET).

6. The current interruption arrangement (1b; 1c) according to claim 1, wherein the current interruption unit (10) has a plurality of power semiconductors (11, 12) for interrupting and establishing the current flow between the battery (70) and the load (200), and the plurality of power semiconductors (11, 12) are connected in series.

7. A battery system (100a; 100b; 100c), having a current interruption arrangement (1a; 1b; 1c) according to claim 1.

8. The battery system (100a; 100b; 100c) according to claim 7, wherein the battery is a motor vehicle battery.

9. The battery system (100a; 100b; 100c), according to claim 7, further comprising a controller (50), the controller (50) configured to divide the thermal energy, produced between the at least one power semiconductor (11, 12) and the at least one surge arrester (30) when interrupting the current flow, between the at least one power semiconductor (11, 12) and the at least one surge arrester (30).

10. A method for interrupting an electrical current flow between a battery (70) and a load (200) by a current interruption arrangement (1a; 1b; 1c) according to claim 1, wherein thermal energy produced between the at least one power semiconductor (11, 12) and the at least one surge arrester (30) when interrupting the current flow is divided between the at least one power semiconductor (11, 12) and the at least one surge arrester (30).

11. The method according to claim 10, wherein the at least one power semiconductor (11, 12) for interrupting the current flow is at least occasionally completely turned off and is at least occasionally operated in an active clamping mode.
